(19) United States
(12) Patent Application Publication
(10) Pub. No.: US 2011/0074804 A1
(43) Pub. Date: Mar. 31, 2011

(54) SELECTION OF A REGION

(75) Inventors: Wei-Chao Chen, Chang Hua City (TW); Natasha Gelfand, Sunnyvale, CA (US); Chia-Kai Liang, Fengshan City (TW)

(73) Assignee: NOKIA CORPORATION, Espoo (FI)

(21) Appl. No.: 12/570,448

(22) Filed: Sep. 30, 2009

(51) Int. Cl. G09G 5/00; G09G 5/02

(52) U.S. Cl. 345/589; 345/581

(57) ABSTRACT

An apparatus includes means for receiving input indicating a selection point; generating a set of paths originating from said selection point; determining an influence value for each point on a path to generate an influence map; and applying said influence map to an image.

### CROSS-REFERENCE TO RELATED APPLICATIONS

This application is related to U.S. application Ser. No. ______, filed on 30 Sep. 2009, (Attorney Docket No. 941-014000-US(PAR), NC69623, 00752-US-P), entitled ACCESS TO CONTROL OF MULTIPLE EDITING EFFECTS, by Wei-Chao Chen, Natasha Gelfand and Chia-Kai Liang, the disclosure of which is incorporated herein by reference in its entirety.

### FIELD

The present application relates to an apparatus and a method for selecting an area of an image for the application of an effect to the image, and in particular to an apparatus, a computer software product and a method for selecting a two dimensional area in one dimension.

### BACKGROUND

More and more electronic devices such as mobile phones, MP3 players, Personal Digital Assistants (PDAs) and computers such as netbooks, laptops and desktops are being used to edit and transform images.

An image can be edited in many ways including changing color tone, color saturation, lightness, high tones, low tones, middle tones, contrast and many other aspects as is known to a skilled person.

Before the effect is to be applied a user selects an object or an area on which, the effect should be applied especially if a local adjustment is to be made. For such regional adjustments a user selects a region possibly comprising at least one object.

In contemporary apparatuses the selection can be done by using tools such as “magic wand”, “magnetic lasso” and color range selection. These techniques are tedious and therefore not suited for quick adjustments on a portable apparatus.

Stroke-based algorithms have been proposed recently to address the need for simpler region selection. Given a few roughly drawn strokes, these algorithms propagate the selection to the entire image through optimization. This paradigm significantly simplifies the selection process.

However, most stroke-based algorithms tend to require a great amount of memory and computational resources, making it rather difficult to is adapt these algorithms to mobile devices.

This presents a problem with portable apparatuses such as portable mobile communication devices and digital photographic cameras as the available memory and computational resources are most often rather limited to keep the price of the product down.

An apparatus that allows fast and easy selection of a region which does not require ample computational resources would thus be useful in modern day society.

### SUMMARY

On this background, it would be advantageously to provide an apparatus, a software product and a method that overcomes or at least reduces the drawbacks indicated above by providing an apparatus, a method and a software product according to the claims.

The inventors have realized that by a careful selection of, modification of and combination of techniques the problem of selecting a region is reduced from an O(n²) problem (that is a problem of the second order or a two dimensional problem) to an O(n) problem or a first order problem, where n is the number of pixels.

According to a further aspect of the teachings herein to overcome or at least reduce the drawbacks indicated above an apparatus is provided, said apparatus comprising a controller and a memory storing instructions that when executed causes the controller to receive input indicating a selection point; generate a set of paths originating from said selection point; determine an influence value for each point on a path to generate an influence map; and apply said influence map to an image.

According to a further aspect of the teachings herein to overcome or at least reduce the drawbacks indicated above an apparatus is provided, said apparatus comprising means for receiving input indicating a selection point; generating a set of paths originating from said selection point; determining an influence value for each point on a path to generate an influence map; and applying said influence map to an image.

In one embodiment the apparatus further comprises means for applying a blurred gradient field to said image when generating said paths.

In one embodiment the influence value is greater in a region where a path is determined not to have encountered any strong edges than in regions where a strong edge has been encountered.

In one embodiment the apparatus further comprises means for interpolating between the paths to generate the influence map.

In one embodiment the interpolation is a scattered bilateral interpolation.

In one embodiment the influence value is the result of an image editing effect.

In one embodiment the image editing effect is one of a tonal, brightness, contrast or color adjustment.

Further aspects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIGS. 1a and 1b are views of each an apparatus according to an embodiment,

FIG. 2 is a block diagram illustrating the general architecture of an apparatus of FIG. 1a in accordance with the present application,

FIGS. 3a and 3b are screen shot views of an apparatus or according to an embodiment,

FIG. 4 is a of flowchart illustrating a method according to an embodiment,

FIG. 5 is a schematic view of an influence map according to an embodiment is a screen shot view of an apparatus or according to an embodiment, and

FIGS. 6a and 6b are graphical representations of gradients and influence values according to an embodiment.

### DETAILED DESCRIPTION

In the following detailed description, the user interface, the apparatus, the method and the software product according to the teachings for this application in the form of a cellular/mobile phone, such as a smartphone, will be described by the embodiments. It should be noted that although only a mobile phone is described the teachings of this application can also be used in any electronic device such as in portable electronic devices such as netbooks, desktop computers, laptops, PDAs, mobile communication terminals and other electronic devices offering access to information.

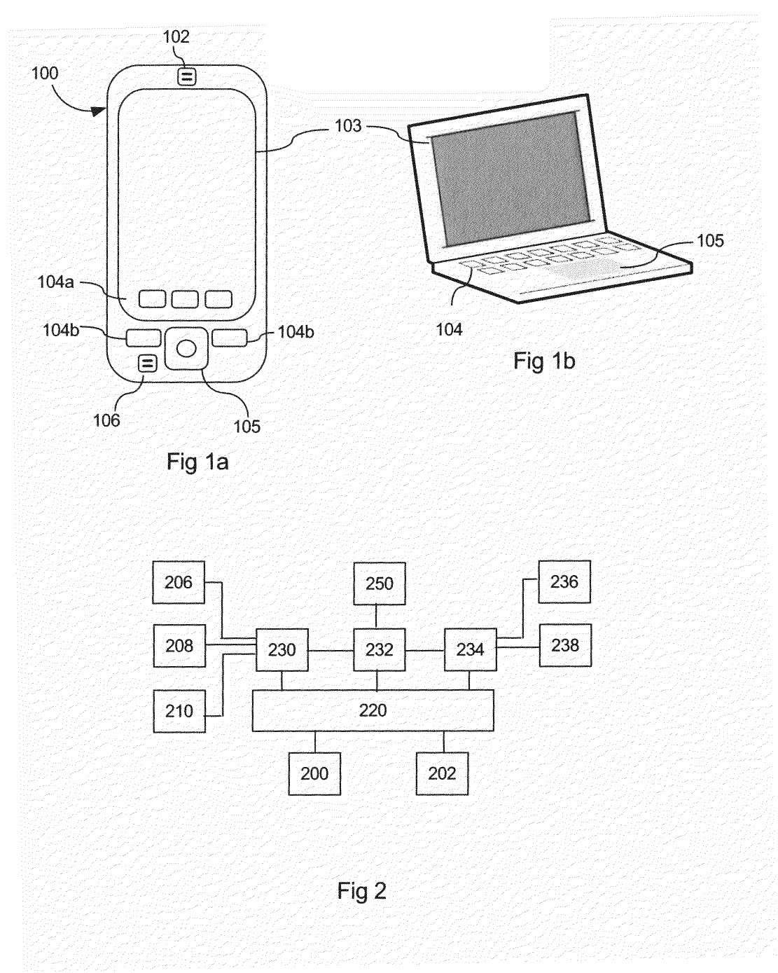

FIG. 1a illustrates a mobile terminal 100. The mobile terminal 100 comprises a speaker or earphone 102, a microphone 106, a main or first display 103 and a set of keys 104 which may include keys such as soft keys 104b, 104c and a joystick 105 or other type of navigational input device. In this embodiment the display 103 is a touch-sensitive display also called a touchdisplay which displays various virtual keys 104a.

In one embodiment the terminal is arranged with a touch pad in addition to or as an alternative to the joystick 105.

An alternative embodiment of the teachings herein is illustrated in FIG. 1b in the form of a computer which in this example is a notebook computer 100. The computer has a screen 103, a keypad 104 and navigational means in the form of a cursor controlling input means which in this example is a touch pad 105.

The internal component, software and protocol structure of the mobile terminal 100 will now be described with reference to FIG. 2. The mobile terminal has a controller 200 which is responsible for the overall operation of the mobile terminal and may be implemented by any commercially available CPU (“Central Processing Unit”), DSP (“Digital Signal Processor”) or any other electronic programmable logic device. The controller 200 has associated electronic memory 202 such as Random Access Memory (RAM), Read Only Memory (ROM), Electrically Erasable Programmable Read-Only Memory (EEPROM), flash memory, or any combination thereof. The memory 202 is used for various purposes by the controller 200, one of them being for storing data used by and program instructions for various software in the mobile terminal. The memory may be formed by separate memory modules. The software includes a real-time operating system 220, drivers for a man-machine interface (MMI) 234, an application handler 232 as well as various applications 350. The applications can include applications for voice calling, video calling, sending and receiving messages such as Short Message Service (SMS), Multimedia Message Service (MMS) or email, web browsing, an instant messaging application, a phone book application, a calendar application, a camera application, one or more video games, a Global Positioning Service (GPS) application etc. It should be noted that two or more of the applications listed above may be executed as the same application.

The MMI 234 also includes one or more hardware controllers, which together with the MMI drivers cooperate with the first display 236/103, and the keypad 238/204 as well as various other Input/Output devices such as microphone, speaker, vibrator, ringtone generator, LED indicator, etc.

The software also includes various modules, protocol stacks, drivers, etc., which are commonly designated as 230 and which provide communication services (such as transport, network and connectivity) for an RF interface 206, and optionally a Bluetooth interface 208 and/or an IrDA interface 210 for local connectivity. The RF interface 206 comprises an internal or external antenna as well as appropriate radio circuitry for establishing and maintaining a wireless link to a base station.

In the following description it will be assumed that the display 103 is a touch display and that a tap is performed with a stylus or finger or other touching means tapping on a position on the display. It should be noted that a tap may also be included by use of other pointing means such as a mouse or touch pad controlled cursor which is positioned at a specific position and then a clicking action is performed. This analogy is commonly known in the field and will be clear to a skilled person. In the description it will be assumed that a tap input comprises a clicking action at an indicated position.

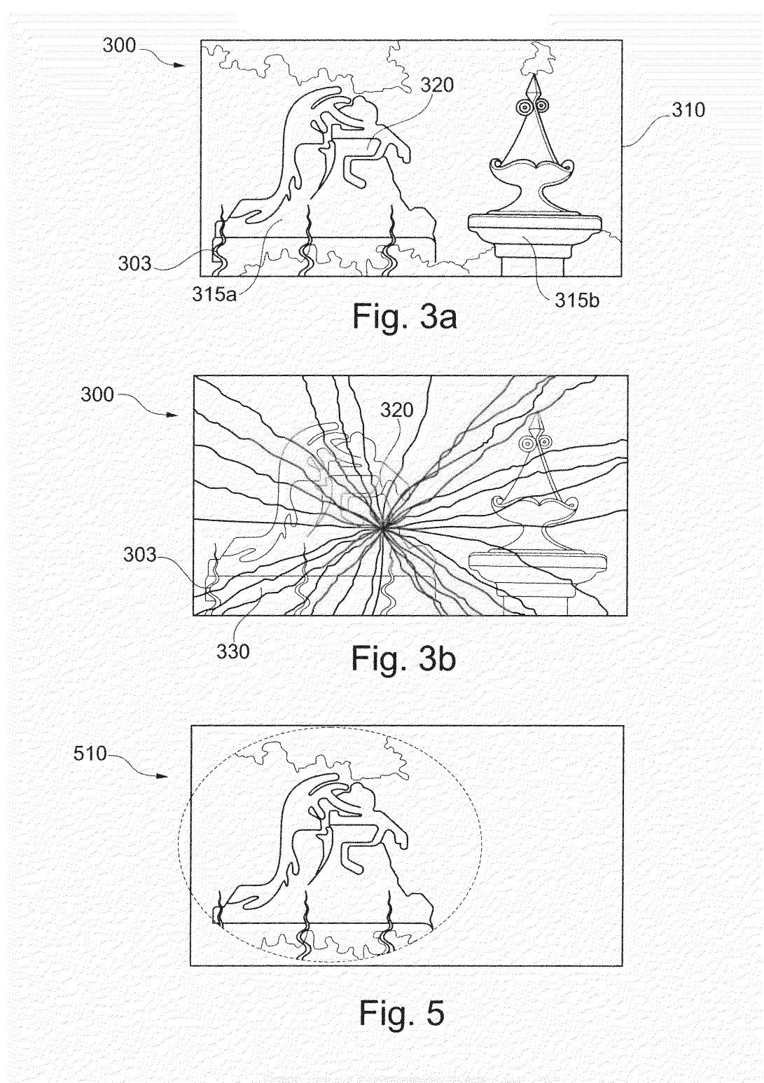

FIGS. 3a-3b show screen shot views of an apparatus 300 according to the teachings herein. It should be noted that such an apparatus is not limited to a mobile terminal, but can be any apparatus capable of editing images, such as notebooks, laptops, cameras, digital image viewers, media players, Personal Digital Assistants (PDA) and mobile phones.

The apparatus 300 has a display 303, which in this embodiment is a touch screen display, hereinafter referred to as a touch display.

In one embodiment a controller is configured to display an image 310 comprising one or more graphical objects 315a and b.

In an example a user selects the left-most object 315a to apply an editing effect by tapping on it.

A common editing effect that users tend to apply to images is tonal adjustment. This effect is often best applied to a region and not a single object as the effects of the tonal adjustment is then spread over an area, often at a varying degree, so that the tonal adjustment blends in with the picture in a natural looking manner.

Contemporary methods such as that described in Lischinski et al [LISCHINSKI, D., FARBMAN, Z., UYTTENDAELE, M., AND SZELISKI, R. 2006. Interactive local adjustment of tonal values. ACM Trans. Graph. 25, 3, 646-653.] have been used to propagate an effect from a selection point to an area surrounding the selection point.

This method requires that a plethora of computations are performed to solve the influence equations at each point in the region thus constituting a two dimensional problem of complexity order O(n²).

By realizing and making the inventive insight that the problem can be reduced to a linear 1 dimensional problem, i.e. of O(n), by modifying the method of Lischinski in that a set of linear paths originating in the selection point are generated and the equations are only solved along these paths and the remaining points in the region are then interpolated great savings in the computational resources required can be made.

In one embodiment the controller is configured to generate regions of interest also called an influence map through edge-ware interpolation.

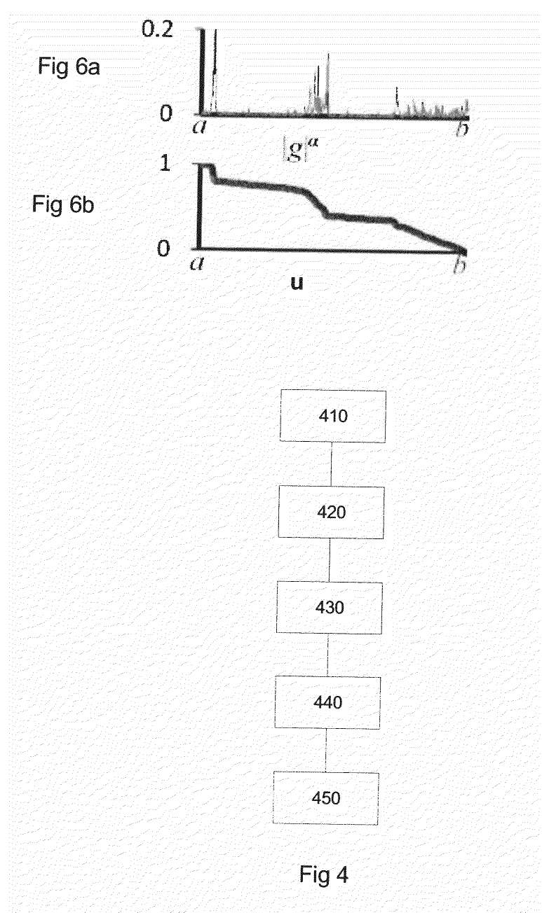

FIG. 4 shows a flowchart of a general method according to one embodiment.

First a single point is selected 410. In FIG. 3a this point is denoted 320. Then 420 a set of paths 330 are generated emanating from the point of selection 320. In one embodiment the paths 330 are guided using a blurred gradient field see FIG. 3b which shows a blurred gradient filed of the image 310 overlaid with the paths 330. Then 430 an effect equation is efficiently solved for influence values along each path 330. Interpolation is then used to generate an influence map for the whole picture 440. In one embodiment the interpolation is a scattered bilateral interpolation. And finally 450 the influence map is applied to the image 310. The influence map represents the selected region for each subsequent image adjustment and the strength of the adjustment.

FIG. 5 shows the influence map 510 for the image 310 of FIG. 3. In the influence map it is indicated that the leftmost object 315a of FIG. 3 should be edited and to become brighter.

The influence map indicates the result of an image editing action. Such an action is one of tonal, brightness, contrast or color to adjustment.

The effect equation (1) solved 440 is according to one embodiment a modified version of the Lischinski equation which is a tonal adjustment equation and will be described below. For further details on the equation please see the Lischinski report as indicated above.

This effective local tonal adjustment algorithm starts with a set of user-drawn strokes and their associated user-specified adjustment values, and propagates them to other pixels in an edge-aware fashion by solving a large linear system Af=b.

Applying the adjustment map solution f to the input image yields the output tone mapped image. For an image with n pixels, A is an n×n sparse symmetrical matrix with up to five non-zero elements per column. Each of the strokes is converted into an n×1 constraint wj whose elements corresponding to the stroke are set to a constant weight such as 1.0. The matrix A consists of two components, A=H+W, where H depends only on the input image, and W is a diagonal matrix whose elements come from the sums of the user constraints as follows:

$$H = [ {h}_{i , j} ] = \{ \begin{matrix}- \frac{λ}{( {\vert {g}_{i , j} \vert}^{α} + ε )} & i \neq j and j ∈ {𝒩}_{i} \\ - {\sum }_{k ∈ {𝒩}_{i}} {h}_{i , k} & i = j \\ 0 & otherwise .\end{matrix} \\ W = {\sum }_{j} diag ( {w}_{j} ) . \qquad ( 1 )$$

For each pixel i, Ni denotes the indices of its four neighbors. gi,j denotes the gradient between two pixels i, j and is computed as the log-luminance differences for High Dynamic Range (HDR) images, and luminance channel differences for Low Dynamic Range (LDR) images. In order to avoid division-by-zero at smooth regions of the image, a regularization term Q is added to ensure the stability of the linear system. λ and α are user-selected parameters that control the sensitivity of solution f with respect to image gradient changes.

The vector b incorporates the user constraints {wj} as well as their corresponding scalar target values {vj}, such that b=Σⱼvjwj. As suggested in Lischinski et al. 2006, one can solve for the contributions of each constraint separately as basis influence functions uj, Auj=wj, such that f=Σⱼvjwj. The vector uj then defines an influence map for constraint wj, and a new image with different sets of target values can be obtained through simple linear combinations of {uj} without solving the linear system again. The basis influence functions however need to be recomputed whenever a new stroke is added because this changes matrix A.

While solving this linear system requires expensive iterative methods using contemporary methods, the solution can be computed very efficiently in 1D according to the teachings herein. As a result, we can achieve our goal by first solving the influence map along 1D paths 330 extending out from the selected point 320. We then fill the gap in this partial solution through bilateral filtering.

Returning to the example of FIGS. 3a-3b, FIGS. 6a-6b shows the gradients |g|^{α} (FIG. 6a) and the influence values u of a path 330 of FIG. 3b (FIG. 6b) from a point a in the selection point 320 to a point b in the edge of the image 310.

To calculate the influence values u we use a method of one-dimensional constraint propagation where we consider the case where each pixel contains only two neighbors, namely when the pixels form a continuous path within the original image, the matrices H and A both become symmetrical tridiagonal matrices. As a result this problem appears similar to a classic partial differential equation in 1D. We provide this new system of n pixels with two boundary conditions in the form of a single-pixel constraint at each end of the path, we have:

$$\begin{matrix}{Au}_{j} = {w}_{j} , j = \{ 0 , 1 \} & ( 2 ) \\ where \{ \begin{matrix}\begin{matrix}A = H + W \\ = H + diag ( {w}_{0} ) + diag ( {w}_{1} ) ,\end{matrix} \\ {w}_{0} = {[ 1 , 0 , 0 , … , 0 ]}^{T} , and \\ {w}_{1} = {[ 0 , 0 , 0 , … , 1 ]}^{T} .\end{matrix} & ( 3 )\end{matrix}$$

For simplicity we denote hi=hi,i+1, gi=gi,i+1, and u₀=[u₀, u₁, . . . uₙ₋₁]T . Taking any two consecutive rows (i, i+1), Vi [symbol] {1, 2, . . . , n−3} from the matrix A and substituting Equation 1 into the system, we obtain this relationship:

$$\begin{matrix}\{ \begin{matrix}{h}_{i} {u}_{i} - ( {h}_{i} + {h}_{i + 1} ) {u}_{i + 1} + {h}_{i + 1} {u}_{i + 2} & = 0 \\ {h}_{i + 1} {u}_{i + 1} - ( {h}_{i + 1} + {h}_{i + 2} ) {u}_{i + 2} + {h}_{i + 2} {u}_{i + 3} & = 0.\end{matrix} & ( 4 ) \\ ⇒ {h}_{i} ( {u}_{i} - {u}_{i + 1} ) = {h}_{i + 1} ( {u}_{i + 1} - {u}_{i + 2} ) , & ( 5 ) \\ ⇒ Δ {u}_{i} {\vert {g}_{i + 1} \vert}^{α} = Δ {u}_{i + 1} {\vert {g}_{i} \vert}^{α} , & ( 6 )\end{matrix}$$

which means that at every pixel i, the change of the influence map Δui=ui−ui+1 should be inversely proportional to hi, or after substituting Equation (1), proportional to the gradient raised to the power α. Notice that we drop the small value ε from Equation (6) because this equation is numerically stable. When λ [symbol] 0, the solutions at the end points are dominated by user constraints and we can efficiently approximate u0 simply as a descent from 1 to 0 that respects the local gradient,

$$\{ \begin{matrix}{u}_{0} = 1 , \\ {u}_{i} = {u}_{i - 1} - \frac{{\vert {g}_{i - 1} \vert}^{α}}{{\sum }_{i} {\vert {g}_{i} \vert}^{α}} , i = \{ 1 , 2 , … n - 2 \} , \\ {u}_{n - 1} = 0.\end{matrix} \qquad ( 7 )$$

We can hereby efficiently compute the influence maps along paths within the image.

To generate the paths 330 of FIG. 3b and to compute their influence values several design choices are to be made. These choices serve to obtain higher accuracy near the user-selected point 320. Also, a path 330 should go through an edge orthogonally if possible so that it would not oversample this particular edge. For this purpose, we compute the paths by first diffusing the image gradients |gi|^{α} outward and having them decay proportionally to the distance. Then, we create random particles emanating from the user-selected point 320 outward, and change the directions of the particles according to the diffused gradient map along the way. This allows the paths to curve toward dominant edges before exiting the image boundaries.

With the set of paths, we need to reconsider the simplistic boundary conditions in Equation (7) which always start with 1 at the user-selected point 320 and drop to 0 where the path 330 exits the boundary 310. This approach introduces artifacts, in particular when the selected point 320 belongs to the same visual region as the boundary. This problem is solved by renormalizing the rate of influence value decay by the largest accumulated gradient over all m paths 330 Gmax=max{G0,G1, . . . Gm-1} where Gj=Σi|gj,i|^{α} is the accumulated gradient along path j. Equation (7) is then revised into:

$$\{ \begin{matrix}{u}_{0} = 1 , \\ {u}_{i} = max ( 0 , {u}_{i - 1} - \frac{{\vert {g}_{i - 1} \vert}^{α}}{{G}_{max}} ) , i = \{ 1 , 2 , … n - 1 \} .\end{matrix} \qquad ( 8 )$$

If a path does not pass through any strong edges before reaching the image boundary, it should belong to the same region that the is user specified. According to Equation (8), the solutions along this path would be close to one; thereby improving the overall quality of the influence map 510.

Because all the paths 330 are solved independently, solutions for different paths could be inconsistent, and proper filtering must be applied to remove this variation. Also, the influence values of two pixels should be similar when they are close or similar to each other.

Therefore an influence map for the whole image 310 is generated through interpolation. In one embodiment the interpolation is a scattered bilateral interpolation. In one embodiment a cross bilateral filter is used.

For an example of such an interpolation see for example EISEMANN, E., AND DURAND, F. 2004. Flash photography enhancement via intrinsic relighting. ACM Trans. Graph. 23, 3, 673-678.

Specifically, for each path, we first splat its solutions to the bilateral grid. We use a 3D grid with two spatial dimensions and one range (intensity) dimension. Even though the paths are continuous in the image, they can become disjoint in the 3D grid along the range dimension when passing through strong edges. To solve this problem a controller is configured to rasterize the 1D paths in the 3D grid to ensure there is no range discontinuity for all the paths. Then three separable 1D low-pass filters are performed along three dimensions for blurring followed by trilinear interpolation to obtain the filtered samples.

In one embodiment the controller is further configured to apply a sigmoid function similar to that described in LEVIN, A., LISCHINSKI, D., AND WEISS, Y. 2008. A closed-form solution to natural image matting. IEEE Trans. PAMI 30, 2, 228-242. to enhance the contrast of the output map.

The stroke-based method by Chen et al. [CHEN, J., PARIS, S., AND DURAND, F. 2007. Real-time edge-aware image processing with the bilateral grid. ACM Trans. Graph. 26, 3, 103] which splats the solutions on the strokes to the bilateral grid is similar to this solution. However, since the strokes are often highly localized in both the spatial and range domains Chen et al. have to perform an additional optimization step to fill the empty grid nodes. In the present method the optimization is not needed because the paths emitted from the clicked point span the whole image, the solutions are densely distributed in the bilateral grid. Thus the present method has a significant advantage compared to that of Chen et al.

Since the bilateral filter can propagate values to similar regions that are not spatially connected, the interpolated influence maps no longer is decrease monotonically as the path solutions originally suggest. This leak-through attribute is particularly useful when a user wishes to select similar regions automatically without computing all-pair affinity. In comparison, using similar constraints, the influence maps generated by Lischinski et al. would include only one object, whereas results produced using the bilateral interpolation process tend to match user intentions better of including similar objects.

The method and apparatus disclosed herein is well-suited to be utilized in a feature such as described in the co-pending US application as indicated above.

Users may desire additional control through adjusting the size, or scale, of the influence map. This is achieved by adding a scale parameter a and replacing Gmax with G′max=σGmax in Equation (8). The solutions along any individual path would tilt up for σ>1 or down for σ<1, effectively changing the size of the influence map.

The method and apparatus described herein combine the influence region control and the image adjustment operations into a single user interface gesture. Upon selecting a point within the region of interest, the user can change the σ value by swiping upward or downward. In the meantime, the system generates a new influence map and presents it to the user for visualization. Once the user decides on a proper influence map, she can adjust the image by swiping toward the left or right. These two operations can be performed in an arbitrary order. Similar user interaction models can also be implemented in a multi-touch device where the relative and absolute positions of two fingers can be used to adjust the scale σ and the image.

It should be noted that a selection method as described above only requires one input from a user, namely the gesture that both selects the originating point (320) and identifies the editing effect and to which degree it should be applied. Furthermore this is all done in a single action from a user point of view.

The various aspects of what is described above can be used alone or in various combinations. The teaching of this application may be implemented by a combination of hardware and software, but can also be implemented in hardware or software. The teaching of this application can also be embodied as computer readable code on a computer readable medium and/or computer readable storage medium. It should be noted that the teaching of this application is not limited to the use in mobile communication terminals such as mobile phones, but can be equally well applied in Personal digital Assistants (PDAs), game consoles, media players, personal organizers, computers, digital cameras or any other apparatus designed for editing image or video files.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user will be able to perform editing actions to a number of objects in an image without the need for vast computational resources.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone and a laptop computer, it should be appreciated that the teachings of the present application may also be applied to other types of electronic devices, such as media players, video players, photo and video cameras, palmtop, netbooks, laptop and desktop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

What is claimed is:

1. An apparatus comprising a controller, wherein said controller is arranged to receive input indicating a selection point;
generate a set of paths originating from said selection point;
determine an influence value for each point on a path to generate an influence map; and
apply said influence map to an image.

2. An apparatus according to claim 1, wherein the controller is configured to apply a blurred gradient field to said image when generating said paths.

3. An apparatus according to claim 1, wherein an influence value is greater in a region where a path is determined not to have encountered any strong edges than in regions where a strong edge has been encountered.

4. An apparatus according to claim 1, wherein the controller is further configured to interpolate between the paths to generate the influence map.

5. An apparatus according to claim 1, wherein the interpolation is a scattered bilateral interpolation.

6. An apparatus according to claim 1, wherein the influence value is the result of an image editing effect.

7. An apparatus according to claim 6, wherein the image editing effect is one of a tonal, brightness, contrast or color adjustment.

8. A method for use in an apparatus comprising at least a processor, said method comprising:
receiving input indicating a selection point;
generating a set of paths originating from said selection point;
determining an influence value for each point on a path to generate an influence map; and
applying said influence map to an image.

9. A method according to claim 8, said method further comprising applying a blurred gradient field to said image when generating said paths.

10. A method according to claim 8, wherein an influence value is greater in a region where a path is determined not to have encountered any strong edges than in regions where a strong edge has been encountered.

11. A method according to claim 8, said method further comprising interpolating between the paths to generate the influence map.

12. A method according to claim 8, wherein the interpolation is a scattered bilateral interpolation.

13. A method according to claim 8, wherein the influence value is the result of an image editing effect.

14. A method according to claim 13, wherein the image editing effect is one of a tonal, brightness, contrast or color adjustment.

15. A computer readable medium comprising at least computer program code for controlling an apparatus, said computer readable medium comprising:
software code for receiving input indicating a selection point;
software code for generating a set of paths originating from said selection point;
software code for determining an influence value for each point on a path to generate an influence map; and
software code for applying said influence map to an image.
